(19) United States
(12) Patent Application Publication
(10) Pub. No.: US 2014/0176319 A1
(43) Pub. Date: Jun. 26, 2014

(54) Provide a system in car that will check if the registered mobile phone is within the range when car is started. If not, it will indicate to user that phone is missing. This will help the user in case user forgets the phone elsewhere. Car circuit can communicate with phone using Bluetooth channel.

(71) Applicant: Kishor Narsinha Nadgauda, Atlanta, GA (US)

(72) Inventor: Kishor Narsinha Nadgauda, Atlanta, GA (US)

(21) Appl. No.: 14/138,063

(22) Filed: Mar. 5, 2014

Related U.S. Application Data
(60) Provisional application No. 61/887,948, filed on Oct. 7, 2013.

(51) Int. Cl. B60Q 9/00; H04W 4/00

(52) U.S. Cl. CPC B60Q 9/00; H04W 4/008
USPC 340/425.5

(57) ABSTRACT

This invention is for additional feature to Bluetooth enabled car or Bluetooth attachment to be used with car which checks if the phone is reachable when car starts. If the phone is not reachable, user would get visual/audible indication. This feature could be turned on or off by the user. This feature extends the existing Bluetooth relationship between car and the phone. This feature would help user avoid the situations where user would forget the phone and drive off to realize it is missing when needed later for critical activities. This feature would add huge value towards convenience and reliability for phone users.

### CROSS-REFERENCE TO RELATED APPLICATIONS

This is a non-provisional patent application related to the provisional application No. 61/887,948 files by myself (Kishor Nadgauda) on Oct. 7, 2013

### STATEMENT REGARDING FEDERALLY SPONSORED RESEARCH OR DEVELOPMENT

Not Applicable

### BACKGROUND OF THE INVENTION

In today's technology driven world, phone is seen as powerful as well as portable device helping us in wide variety of personal as well as professional activities. We use the phone for storing critical information, contacts, events and business reminders etc. That is making us more and more dependent on phone. In busy day it sometimes happens that we head out to office leaving the Phone at home or may be forget phone in restaurant and drive back home. In this situation, if we do not have phone with us when needed, we may miss important calls or crucial business meetings. It is major inconvenience to have forgotten the phone and not having it handy. On the other hand if we forget the phone in public place and lose it, we lost the personal information with it as well and that can cause major problems. Most of the times, chances of missing phone are when we forget it and drive away. That is where the idea of ensuring that the phone is with us when we are on ride comes in handy.

### BRIEF SUMMARY OF THE INVENTION

This invention focuses on idea of ensuring the user has phone with her/him when she/he starts to drive away in the car. That way before person can leave without the phone, system reminds the user that phone is missing. With that user gets chance to make sure she/he takes phone before getting off. This way user is saved from future potential problems she/he may go through because of not having phone handy when it is needed or even losing the phone occasionally. Pairing of Bluetooth enabled phones with car is very common these days. The phones are paired with either built in Bluetooth unit if car has it or with add-on attachment that is Bluetooth enabled. My invention applies to phones paired with either of these options. I am introducing a concept here to ensure the paired phone is in reach when the car starts off. If the phone is out of reach, user would be notified.

### DETAILED DESCRIPTION OF THE INVENTION

Almost all the cars designed these days have Bluetooth connectivity to Bluetooth enabled phones. This invention is addition of feature that extends the relationship between phone and car to ensure phone is in range when car is started. The invention discussed here relies on Bluetooth connection from car to the phone, it also assumes that the phone is paired with the car with the protocol specified by the device used in the car.

With this feature, when the car starts, car's Bluetooth unit will send message to Bluetooth enabled phone. The Bluetooth connection works in a specific range of distance. If the phone is in reach, connection between car and phone would be established. If the phone is not in reach, device will provide visual and/or audible indication to user. The means of communication between car and phone depends on the car's Bluetooth device as discussed in the sections below:
1. The car may be equipped with built in Bluetooth capabilities. In this case the device in the car would communicate to Bluetooth enabled phone when the car is started. Visual and/or Audible indication for missing phone would be provided on the built in device.
2. The cars that are not Bluetooth enabled may use the Bluetooth kit. In this case the device attached to the car would communicate to the Bluetooth enabled phone when the device is turned on. Visual and/or Audible indication for missing phone would be provided on the attached device.

In either case, additional feature would be configurable that user can set on or off.

1. I claim introduction of additional feature in Bluetooth enabled car, as enhancement to the existing relationship between car and paired Bluetooth enabled phone that consists of:
a. Communicate with paired Bluetooth enabled phone when car starts and if the phone is not reachable then provide visual and/or audible indication to user for missing phone.
b. The missing phone Indication would turn off automatically after specified time (around 30 seconds) or when acknowledged by the user.
c. Allow user to turn on or off this feature.

2. I claim introduction of additional feature in Bluetooth attachment devices used for cars, as enhancement to the existing relationship between Bluetooth attachment device and paired Bluetooth enabled phone that consists of:
a. Communicate with paired Bluetooth enabled phone when the car starts (when the attachment is turned on when car is on) and if the phone is not reachable then provide visual and/or audible indication to user for missing phone.
b. The missing phone indication would turn off automatically after specified time (around 30 seconds) or when acknowledged by the user.
c. Allow user to turn on or off this feature.
